(19) United States
(12) Patent Application Publication
(10) Pub. No.: US 2018/0374383 A1
(43) Pub. Date: Dec. 27, 2018

(54) COACHING FEEDBACK SYSTEM AND METHOD

(71) Applicants: Jeffrey Thielen, Lino Lakes, MN (US); Andrew John Blaylock, Minneapolis, MN (US)

(72) Inventors: Jeffrey Thielen, Lino Lakes, MN (US); Andrew John Blaylock, Minneapolis, MN (US)

(21) Appl. No.: 16/015,920

(22) Filed: Jun. 22, 2018

Related U.S. Application Data
(60) Provisional application No. 62/523,470, filed on Jun. 22, 2017.
(60) Provisional application No. 62/523,479, filed on Jun. 22, 2017.

(51) Int. Cl. G09B 19/00; G06T 19/00; G09B 5/06; A63B 69/00; A63B 71/06

(52) U.S. Cl. CPC G09B 19/0038; G06T 19/006; G09B 5/065; A63B 69/00; A63B 2102/32; A63B 2220/806; A63B 2071/0647; A63B 2071/0666; A63B 2071/0625; A63B 71/0622

(57) ABSTRACT

System and methods may provide coaching feedback. An example method may include presenting a visual display of a target movement pattern for a user to mimic. The user may be tracked during an attempt to mimic the target movement pattern. Real-time feedback may be provided, for example during the tracking. The feedback may include a visual effect separate from the target movement pattern. For example, the visual effect may indicate a deviation of the attempt from the target movement pattern. In an example, the visual effect may be an arrow, a change in background color or pattern, or the like. In an example, instead of or in addition to the visual effect, an audible effect may be used.

### CLAIM OF PRIORITY

This application claims the benefit of U.S. Provisional Patent Application Ser. No. 62/523,470, filed on Jun. 22, 2017 and claims the benefit of U.S. Provisional Patent Application Ser. No. 62/523,479, filed on Jun. 22, 2017, the benefit of priority of each of which is claimed hereby, and each of which are incorporated by reference herein in its entirety.

### BACKGROUND

Users may generate their own feedback when practicing movement skills. This could be feedback about the details of their motion which they acquire through proprioception. It could, alternatively, be feedback about the “success or failure” of their movement, generated by observing the results.

Many systems have been devised to provide movement skills feedback in real time. In general, feedback is communicated through a sensory channel and, as such, engineers have, to this point, had success with audio, visual, and tactile feedback systems in real time. So far, these efforts have been limited to systems that have provided feedback in real time in a way that is limited to accommodating a narrow set of similar techniques or a single technique.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for providing coaching feedback in accordance with some examples.

FIG. 2 illustrates background patters in accordance with some examples.

FIGS. 3A-3B illustrate corrective angles (3A) and corrective arrows (3B) in accordance with some examples.

FIG. 4 illustrates a flowchart showing a technique for provide coaching feedback in accordance with some examples.

FIG. 5 illustrates a flowchart showing a technique for building an animation scenario in accordance with some examples.

FIG. 6 illustrates a flowchart showing a technique for animation of video segments in accordance with some examples.

FIG. 7 illustrates a block diagram for supervised machine learning training in accordance with some examples.

FIG. 8 illustrates data correlation graphs in accordance with some examples.

FIG. 9 illustrates a graph showing a first technique for skeleton recognition in accordance with some examples.

FIG. 10 illustrates a graph showing a second technique for skeleton recognition in accordance with some examples.

FIG. 11 illustrates a block diagram of an example of a machine upon which any one or more of the techniques discussed herein may perform in accordance with some examples.

### DETAILED DESCRIPTION

Systems and methods described herein provide feedback to a user attempting to complete a target movement pattern. The feedback may include audible or visual feedback. The feedback may be presented separately from a target or path shown for the user to mimic (e.g., the target movement pattern). For example, a change in background color or pattern, or a corrective audible sound may be presented as feedback to direct the user to change an aspect of the user's movement.

When learning a new skill, exercise, activity, or action, self-generated feedback is the starting point to intervene in the learning process in a positive way. Traditionally, additional feedback is added to the mix by a human coach who understands the technique at a deep level and may provide information both prior to and after the learner's attempt to execute a movement skill. However, self-generated and coaching feedback is limited in perspective and knowledge.

Systems and methods described herein may quantify user body position in order to perform analysis targeted at providing information about how the user may improve movement or skills. To do this, the systems and methods described herein provide may demonstrate a target movement pattern and track the user's skeleton as the user attempts to match the demonstrated movement pattern. In an example, the systems and methods described herein may guide the user toward a movement pattern that largely matches the one demonstrated to them (e.g., ask the user to attempt to mimic the movement pattern).

Advantages to these systems and methods include an ability to simultaneously monitor parts of the body with full attention, whereas a coach may effectively only focus on one part of the user's body or one phase of the technique at a time. Another advantage that a computerized coaching system may enable is the ability to generate and communicate feedback in real time. In another example, delayed video feedback may be used.

The systems described herein may be adaptable to the full breadth of human movement techniques and to feature real time feedback across two feedback sensory modes for movement skills (e.g., visual and audio). Additionally, or alternatively, the systems described herein may include tactile feedback, smell, or taste. The systems described herein may use multiple techniques or multiple sensory channels.

Real time feedback typically offers information about the degree to which the user is matching the “correct” version of the technique. Real time feedback provides an “example” sound sequence or visual sequence. These examples are produced in advance by applying an expert version of the technique in question to the feedback generating system. Then, over a series of trials the user learns to match the sound sequence or visual sequence with their own motion. In the systems described herein, a new type of real time feedback may offer correctional information in real time using background pattern, background color, or arrows. The addition of real time correctional feedback allows for improvements to better optimize the full skill acquisition process. In an example, the feedback types may be mixed.

There are different types of feedback. Corrective feedback gives specific information about how to correct (e.g., what direction to move), while convergent feedback changes in character based on proximity to the target so the user can follow a “gradient of improvement” to the target.

A first example feedback includes a delayed corrective feedback. In an example, in a first phase, the user is still acquiring a full conceptual knowledge of the technique itself while starting to lay down circuitry to produce the movement. In this stage, feedback may be delayed because the user may not effectively process real time feedback while focusing their mental energy on attempting the skill.

A second example feedback includes real time corrective feedback. In an example, in a second phase the user has acquired the cognitive understanding for the technique and has some motor control circuits built. At this point, the user may accurately perceive the information provided via corrective real time feedback to guide them into the correct position and timing.

A third example feedback includes real time convergent feedback. In an example, in a third phase, convergent real time feedback may be used to hone the final details of the technique.

In an example, delayed convergent information may be useful as well in cases to help users review the nature of the feedback pattern an expert produced against their own to help them better hone in.

This entire sequence may be used each time a user learns a new technique. There are techniques that are commonly used in a movement skill discipline during a performance. There are also elements of those techniques that are commonly used during the development process to build movements that are used in performance in a step by step way. These may be called “subskills.” In an example, subskills are also techniques and they may be taught within the system. For each movement skills discipline a progression may be determined, which may define an order in which these techniques are introduced and developed with a user.

In an example, within the process for a given technique, the systems and methods described herein may provide feedback specific to a subset of the body segments that comprise a full human body. In an example, a progression for a technique may start with certain body segments (e.g., those closest to the core or the feet). Within each technique (e.g., performance skill or sub-skill) more than one progression may be used. The one that has already been discussed is the sequence of feedback types (e.g., delayed, real time corrective, real time convergent). The other progression includes a body part focus. In another example, subskills progression may be used as a focus.

A technique or body part focus may be trained to completion or may be interrupted before completing by starting on another of either. A complex sequence of activities may be used when working through an entire progression of a discipline. Another dimension to the progression process is performance velocity. Humans are capable of performing techniques with nearly identical relative timing at different absolute speeds. Slow motion execution may be valuable in the early stages of learning a technique. In an example, a “slow to fast” dimension to the progression may be used for an exercise or technique.

In an example, audible language may not be used to provide real time corrective feedback. In another example, a more intuitive form of communication may be used, such as audible or visual cues. The user may acquire an intuitive understanding of the audio and visual keys. Some sounds may indicate a need to move a body segment in a particular direction. Certain visuals may indicate the user needs to speed up the movement. Other examples or combinations of audible or visual effects may be used.

Early in the user's process of getting familiar with the system, posing and slow motion exercises with multi-modal feedback may be used. An example mode may include a visual “graphical arrow” that has intuitive meaning relative to the 3D space around the user's body. The user may move according to the arrow and, as the user moves, additional visual and audio patterns that correlate to the same corrective information may be presented. These various cues may be called a “common language” herein.

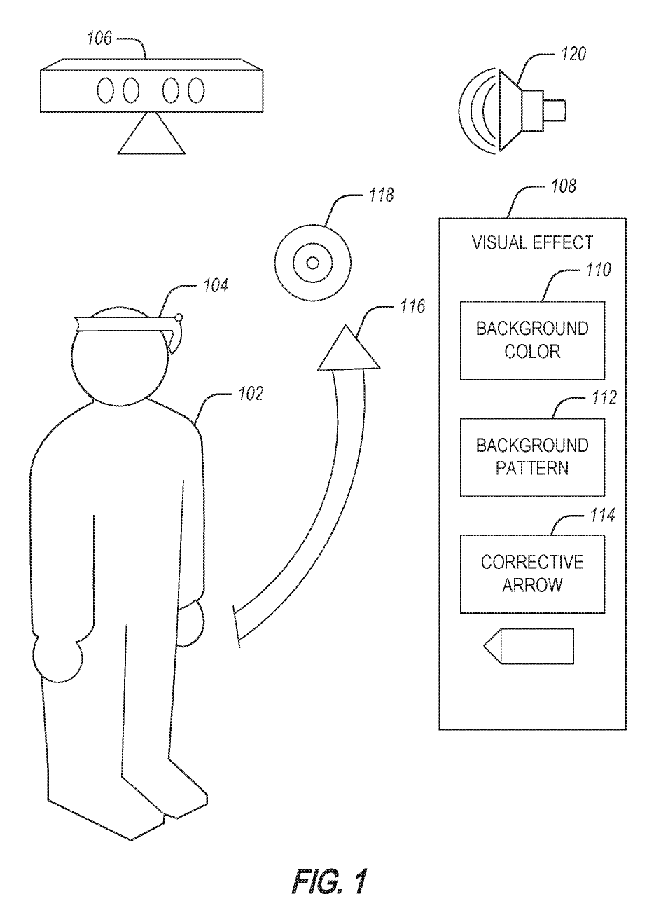

FIG. 1 illustrates a system for providing flexible real-time feedback in accordance with some examples. The system presents visual effects using a display, such as a headset 104 (e.g., an augmented reality, hologram, projector, 3D display, or 2D display). The system presents audible effects using a speaker 120, such as a standalone speaker or a headphone speaker. A user 102 may use the system to acquire or improve skill in a movement or technique. Movements of the user 102 may be monitored by a device 106, such as a skeletal sensor, depth sensor, position sensor, or the like, to track movement of the user. The user 102 may be presented with a target movement pattern including a benchmark spatial path 116. The target movement pattern may include an end target 118. The target movement pattern is a general performance of a technique and may be displayed using a humanoid avatar. For instance, a target movement pattern may be “throwing a football,” “performing a slap shot,” or “swinging a sand wedge.” Within a target movement pattern may be one or more benchmark spatial paths. The benchmark spatial paths are specific paths through 3D space for a portion of a person's body, such as a joint, a body segment, or the like. For instance, one benchmark spatial path may track be constructed from the position of an expert's wrist during a baseball throw. As another example, a benchmark spatial path may be a representation of an expert's waist while swinging a golf club.

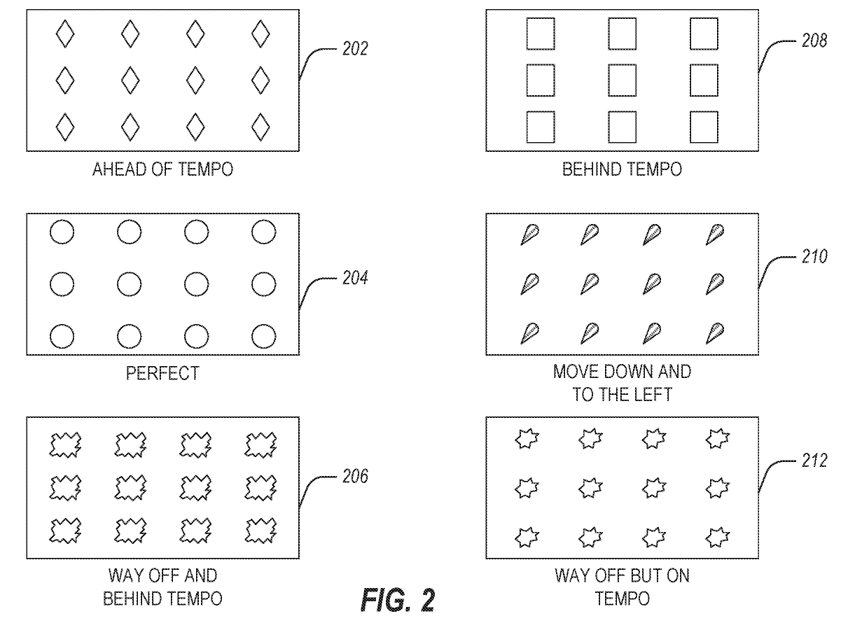

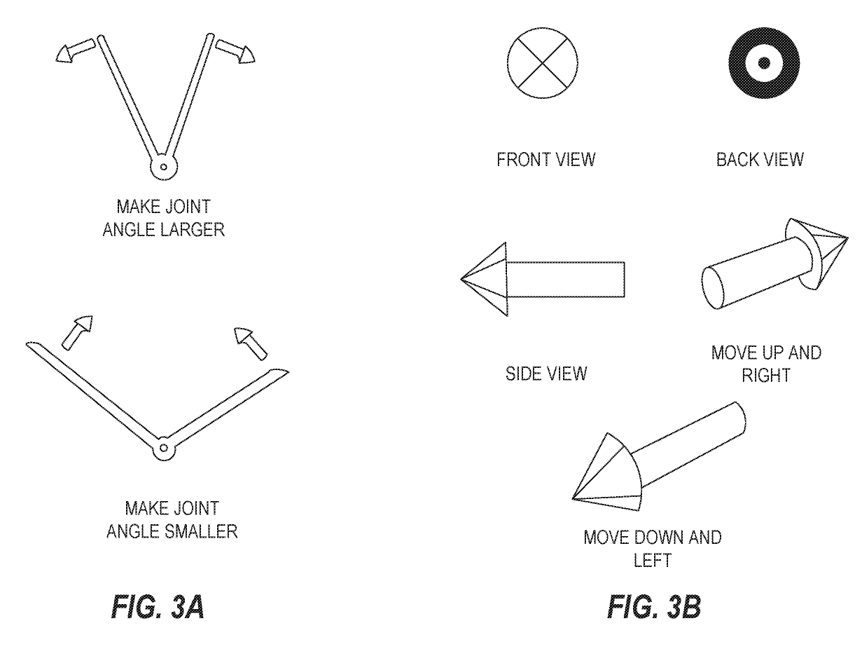

As the user 102 performs or attempts to mimic the target movement pattern, the user 102 may be presented with a visual effect 108. The visual effect 108 may be separate from the target movement pattern. The visual effect 108 may include a change in background color 110, a change in background pattern 112, a corrective angle, or a corrective arrow 114. These visual effects 108 are described in more detail below with respect to FIGS. 2-3.

Many sports revolve around the idea of placing some object in players' hands and demanding the user to become increasingly adept at manipulating that object toward a certain goal. The system may include have an optical sensor that tracks the human body rather than sensors on the held object (such as an accelerometer). The system may use measurements from the device 106 to enable sonification (the term “sonification” may be used in portions of this document, while in other portions the more general term “real time feedback” may be used; sonification refers to intuitive audible feedback, for example with different parts of an audio range having different meanings for corrective feedback).

In an example, it may not be useful to try to generate sound that represents the information from all of the user's joints at once. The best real time feedback is “manageable” in terms of the amount of information provided and when it is perceived. The system may track all joints at once, but may focus in on specific body segments and joints in a progressive way when providing feedback. For a given technique an example initial progression may include focusing on the body segments and joints closest to the body's contact point with the ground, work to the core, and then out to the extremities in this progressive sequence. Alternatively, focus on the body segments and joints chronologically earliest in a technique may be progressed first. In an example, it is likely that there may be “relatively unimportant” joints or body segments that may be omitted from the progression. The system may be flexible in focusing on certain parts of the body interchangeably when generating real time feedback (e.g., ignoring or not emphasizing unimportant joints or body segments).

When producing sound for “convergent” sonification, the system's dynamic center of frequency may be around 2000 to 5000 Hz. In an example, the visual effect 108 may occur when the sound is in that same target range. In an example, for a given technique, the optimal angle for a certain joint may be 10 degrees, 175 degrees, or anywhere in between. The system may match whatever the target joint angles are to the target sounds and visuals. The target sounds or visuals may be provided to the user 104 in a tutorial, for example, so that the user 104 is able to quickly and easily understand the meaning of these signals.

Audible or visual feedback may depend on a range of user movement outside the target movement pattern for that given technique and body part. When the body part within this movement is inherently well constrained, even a novice may not get far out of position (e.g., even a big mistake may be only a few degrees from the target angle). On the other hand, when constraint is minimal, the user may move far out of position. Further, in complex movements, a performer may be right on the whole time and still go through a wide range of angles with a given joint meaning that the “target” angle for that joint changes dramatically depending on what stage in the technique the user is at.

For a technique and body segment choice, a mathematical function may be used to manage achieving a match in the dynamic range of the input joint angles and the dynamic range of the output sounds and visuals. In each case, this function may use joint angle as input and output the audio and visuals including sensitivity to changes in the input angle adjusted to match the expected range of degrees that joint undergoes for that movement. The system may output in roughly the same audio range across different ranges of input joint angles on a case by case basis for different tasks and joint choices, fostering a consistent “audio language” the user may work with to converge to excellent technique.

Another way in which the output function may adapt is via user choice. To fit in with the human musical system, various instruments play a common set of notes which may have the same vibrational frequency. The richness and variety in musical instruments comes from the harmonic structure that they possess. When engineered to produce pleasant sounds, this harmonic structure supports whichever main note is played. The system may use a main note in audible feedback that fits the scheme established above where the target positioning may be signified by a target “note” between 2000 and 5000 Hz. The user may then choose from pre-defined harmonic structure choices. The user may choose from a selection of “instruments” or other schemes featuring harmonic structure profiles that are interesting and pleasant, and which may be changed later. Similar schemes for visual customization while maintaining a common visual language may be used.

A distinction is that in convergent feedback, a target sound or visual sequence is displayed and the user then tries to use their own motion to generate a sound profile or visual pattern which matches the previously displayed sequences of either or both. With practice the expectation may be that they become closer and closer over a series of attempts. In corrective mode, the user learns the motion and then attempts the motion, with the system providing information that tells the user how to correct if the user is out of position in space or time.

In order for the system to produce corrective real time feedback, the system may compare the user to a target model (e.g., using a processor of a computing device). This model may contain the information about how an expert moves when attempting the same technique. The model may be used as the benchmark spatial path 116, or the benchmark spatial path 116 may be derived from the model. As before, the system may not overload the user with information so it and the user may focus on one body segment or joint at a time. As the user moves, the system provides audio and video information telling them to move that body segment into the correct position or confirming that it is indeed in a correct position. After the user learns to correct their movement with respect to this body segment, they may move to another movement. By swapping in a new expert technique, the system may adjust to accommodate training of diverse techniques.

In an example, the system may find that the velocity, acceleration, or the jerk (3^{rd} derivative of position) of a body segment is an aspect that may be matched during a certain portion of a technique (e.g., instead of or in addition to position). Velocity, acceleration, or jerk may be used as the input to a function that generates a real time feedback signal.

A technique for establishing approximations to the 1^{st}, 2^{nd}, and 3^{rd} derivatives of position from skeletal tracking may be used. For example, this value may be 3-dimensional positional data for the skeleton or the joint angles derived from the positional data. This positional data may be arranged in a sequence defined by the time that it was captured from earliest to latest. Then, by subtracting earlier values from the value immediately following, the delta (e.g., change) for each time interval may be calculated. This sequence of delta values approximates the first derivative of position, the velocity. Acceleration may be calculated by determining the delta values for the delta (velocity) series. This may be iterated once again to get to jerk values.

Feedback may be generated from any of these sets of values. Different methods may be used for different given tasks. In an example, up to a limit where the user is overwhelmed, an overlay of multiple feedback signals may be provided with information about two or more of these qualities (position, velocity, acceleration, or jerk) at once. This may add a richness to the sound experience which may make the experience more enjoyable.

In an example, parameters may be swapped from one exercise to another, such as an ideal technique model, technique execution speed (slow motion or full speed execution), body segment or segments (to focus the real time feedback generation on), output function (to account for the expected angle range and optimal target position for the joint angle measurement for the body segment and technique), feedback type (delayed corrective, real time corrective, real time convergent, or delayed convergent), feedback sensory mode (audio, background color, background pattern and corrective arrow, or a subset thereof of feedback mode options), data type to act as input to output function (position, velocity, acceleration, or jerk), or the like.

FIG. 2 illustrates background patterns in accordance with some examples. Background pattern examples 202-212 may be used for indicating feedback to a user in an intuitive way that does not interfere with the user attempting the exercise (e.g., focus may remain on the target movement pattern and peripheral or momentary attention may be paid to the background feedback). The examples shown in FIG. 2 may be changed without deviating from the scope of this disclosure. In an example, a user a student or coach) may modify the background patterns.

By way of example, background pattern 202 illustrates feedback indicating that the user is ahead of tempo in the user's movement. Background pattern 204 illustrates feedback indicating that the user is on target in the user's movement. Background pattern 206 illustrates feedback indicating that the user is way off of the target movement and behind in tempo in the user's movement. Background pattern 208 illustrates feedback indicating that the user is behind tempo in the user's movement. Background pattern 210 illustrates feedback indicating that the user is to move down and to the left in the user's movement in order to more accurately follow the target movement pattern. Background pattern 212 illustrates feedback indicating that the user is way off target but on tempo in the user's movement.

Research has demonstrated that feedback across multiple sensory modes as opposed to a single mode offers benefits to the rate of learning. There are two very straight forward modes that people may easily use in concert within a learning situation—audio and visual. Corrective and convergent feedback were previously discussed. The distinction between the two may be especially useful when considering real time feedback and both types may be used during delayed feedback as well. When considering audio feedback, the distinction may be used in real time as convergent feedback via the audio channel may not be very useful when delayed. And, within the audio channel, convergent and corrective feedback may not be used simultaneously.

In an example, more than one visual scheme may be used at a time. For example, background color, background pattern, or a corrective arrow (described in more detail below with respect to FIGS. 3A-3B) may be used to indicate feedback.

The background color information is an indirect form of information. It does not directly tell the user anything about their movement. For example, it instead relies on associative learning so that the user eventually associates certain colors with certain information. The background pattern is indirect during a convergent feedback mode, but may be direct during corrective feedback. The pattern may be made of geometric shapes and these shapes may be made with a pointed portion which may point in a certain direction to indicate the desired corrective action. So, depending on how it is used, it may be indirect or direct. The corrective arrow is used specifically to convey corrective feedback and may point in a direction to indicate what the user does to correct their movement. As such it is direct.

In an example, direct feedback is direct because some aspect of the visual may literally point in the direction of the desired correction. Indirect feedback may convey the same information, but not until the user has mentally associated indirect patterns to correlated direct corrective information.

Different real time feedback modes may be used with visuals according to:
1) Corrective Real Time Feedback

a) Background color—indirect information

b) Background pattern—direct information

c) Corrective arrow—direct information
2) Convergent Real Time Feedback

a) Background color—indirect information

b) Background pattern—indirect information

In an example, the audio channel may be used in conjunction with visual feedback. In an example, the audio channel provides indirect information. In another example, the audio channel provides direct information (e.g., spoken words directing the user).

In an example, a directional speaker may he used. Directional speakers are a technology that, given enough power and if playing sounds of the right frequency, may produce tactile sensations on the skin without producing an audible sound. The directional speakers may be used to provide direct corrective information within a real time feedback scheme.

In an example, a target movement may include executing a slow motion baseball pitch. When a throwing hand is too far to the right, for example, the directional speakers may direct vibrations through the air targeted at the right side of the hand to “nudge” the hand to the left. This vibration gives the user the psychological impetus to make the correction.

In an example, feedback language intuition development may be used to teach a user how to intuitively understand the meaning behind the types of real time feedback provided by teaching the language within which the information is provided.

In an example, in the case of sonification, the user may be taught to intuitively and automatically understand the audio range used and what the different parts of that audio range mean. For corrective feedback, specific sound variations may have specific corrective meaning (e.g., “move in this direction”, “move slower”, or “move faster”). This may be taught through a series of posing exercises or slow motion exercises. The specifics for the exercises are explained below in more detail below related to proprioception and feedback language intuition. These exercises may have additional benefits of developing balance as well.

For convergent feedback, the visual and audio information may be relative to a visual and audio target pattern so, in the case of sonification for example, the frequency by itself may not indicate which way to move. In an example if the joint in question is at too small of an angle, the audible pitch may be higher (in one example) than the target pitch and the user may increase that joint angle to make the sound match their memory of the target sound. In an example, the opposite may be true if the angle was too wide. A similar consistent scheme may be used for background color and background pattern. As in the sonification case, the user may learn the consistent schemes for background color and background pattern through slow motion or posing exercises. During the learning process for this convergent information, in an example, some corrective information may also be provided in the form of a visual that indicates that the angle is too large or too small. This may be called the corrective angle adjuster.

To accomplish this learning process, posing exercises or slow motion exercises, and association with the information from direct information sources such as the corrective arrow and the corrective angle adjuster may facilitate a learning process that guides the user into making this indirect information intuitive and automatic.

In an example, a method may provide proprioception development (and feedback language intuition continued) to build on and continue the education of the user on the meaning behind the feedback provided. The method may allow for simultaneously making the user's proprioception system more salient and accurate. Proprioception is like a body's internal motion capture system.

Certain exercises may be better for developing intuition about the feedback information. Other exercises may be well suited to developing proprioception which is each person's internal real-time feedback system. A method for proprioception development may include the following exercises.

An example exercise includes target hitting. A system may present a target in the space around the user and direct them to move a specific part of their body to the target position. In the case of an immersive headset, this target may be displayed in the virtual space around the user's body. The user may turn their head to see the target and then reset before trying to move their body segment to the target. In the case of a traditional screen, an image of their body may be shown with the target displayed in a position relative to the image of the user's body. The target on the display screen may be positioned so that it correctly illustrates the position of the target within the space that surrounds the user. Multiple angles or a moving perspective may be used to fully convey the location of the target in the area around the user's body.

When the user has a high fidelity 3D spatial sound system at their disposal, the target location may be displayed in the space surrounding their body with audio as well, effectively creating the impression that the target location itself is generating a noise that they may use to understand the target's location in space.

When ready, the user may move the directed body part to the target. While the user attempts to hit the target, the real time feedback system may provide corrective feedback to guide the user to the correct position. When the user does not have familiarity with corrective feedback information, the system may optionally display an image of their body and the target as they move to help them understand where they move to zero in on the target. This allows for associative learning with the other forms of real time feedback.

Another example exercise includes target following. Target following works like target hitting, and involves a moving target. This may work up to somewhat fast speeds, and may be done at low speed initially. The target movement, whether conceived to naturally cycle back to the starting point or not, may be set up as cyclical. In other words, the movement may have a natural start and end. If those are not in the same place, it may be modified to add a movement that cycles back to the starting point. By way of an example, imagine that the motion of the target in this case could actually be defined as being similar to a golf swing. A golf swing has a start and an end that are not in the same place. To make a golf swing cyclical, a motion may be added (which may be kept as simple as possible) from the end point back to the start point so the golfer may repeat the technique. A target hitting task may be modified in a similar way. As a result, for a few repetitions before the user actually tries the target following exercise, the user may watch the target motion and learn how it moves before making repeated attempts to track that movement with the body segment which has been directed.

Another way to understand this is to consider the difference between examples of discrete movements (such as a baseball pitch or a golf swing) and examples of cyclical movements (such as a running stride or bicycling). Being able to visualize that difference should help in understanding how the following scheme can turn a discrete movement into a cyclical movement. A target following movement may be made cyclical by adding a movement back to the starting point and, as such, allow the user, through immediate repetition, to get closer and closer to the target with each cycle.

Another implementation may keep the target still at first until the user “hits” the target with an intended body segment (“hits” is in quotation marks here because the target is virtual). The target may start moving once that “contact” is made. In this case, the user may preview the movement a few times before trying so that the user knows where the target is going to move once the user does make contact.

An example exercise includes target hitting eyes closed with and without corrective sonification. When focused on building intuition about corrective sonification as described above, the target may be presented before the user closes their eyes and attempts to hit it. The user may converge to the target while sonification information is provided. When focused on developing proprioception, input from the eyes may be eliminated. In an example, corrective sonification may be used. As such, exercises where a target is presented and then the eyes are closed while the user tries to move their body segment to the target may be useful with and without corrective sonification.

Another example exercise includes target following eyes closed with and without corrective sonification immediately after observing a target motion example with and without human model image. This exercise tasks a user with following a pre-presented target with the eyes closed using a specified body segment. This adds the element of a moving target. Once again, there is use for doing this with and without corrective sonification. In this case, the observation of the target motion before attempting, may include observing an example human image demonstrating the motion that follows the target with the specified body segment.

Any of the above exercises may be used with balance exercises. Any of the above exercises may be executed on a single leg or with some other variation of a balance challenge to further step up the total-body proprioception load. When a balance challenge is added, the exercise becomes more advanced than it would be without.

Pose matching may be used to train the user. Pose matching is akin to providing a whole body's worth of targets and specifying the body segments that may hit each target. The complication is that the user may not focus on all body parts at once, so corrective real time feedback may be presented sequentially, one body segment at a time, for example. An alternative to this is to simply display a visual “skeletal overlay” where the model skeletal position is overlaid on user's skeletal position. Then, the user may visually scan the overlay and ensure their mental attention is on moving the joint that they are looking at into position so it may match the overlay.

When sequentially providing feedback, high precision may be required with each body segment before moving on to a next joint. While the user focuses on that joint, more relaxed precision may be used for the areas they are not focused on. In an example, if after effort is made to get a body segment in the correct position, it drifts out of place while focusing on a different segment, the system may have circle back to get it back into the correct place.

Many poses may place high energy demands on certain body parts leading to an overload of fatigue. This may be accounted for by stopping the pose exercise after a certain amount of time regardless of whether the user has hit the target(s) or not.

Pose sequence matching a set of discrete target poses may also be used. Once the user is proficient with pose matching, the system may move the user on to pose sequencing. With more relaxed tolerances, the system may ask the student to match a sequence of poses, moving on to the next pose once they have gotten to within tolerances on the current one. In this way they may build the full motion of a technique they are learning.

Continuous movement matching after initial position match (short sequences) may be presented. A pose matching challenge may ask the user to match an initial pose and then follow a continuous motion after this first pose match has been achieved. For any given technique, this starting pose may be at any part of the technique, beginning, middle, or near the end. In this way, correct position in any or all phases may be taught. This may be done with significantly reduced speed motion. With this exercise, corrective real time feedback may be used in any of the following combinations: not at all, pose, motion following the pose, during the pose and during the motion, or the like.

The method for developing proprioception (and feedback language intuition) may be developed over iterative trial and error. In an example, a framework may be established that reflects likely exercises the system will use with the user in the future. The (progression-ordered) list of tools that may be used in that process above is one framework of this type. The following three phased structure is one as well. It applies these tools essentially in the same order as above, and puts more structure into the training process by applying a simple, medium, and complex phase.

### Phase 1—Simple

The first phase seeks to establish basic proprioception without the complication of applying real time feedback that the user is not ready to understand intuitively. Delayed feedback may be used to allow the user to check their performance and adjust.

In the simple phase, the system may start with basic target hitting tasks executed without time pressure or with minimized time pressure.

Once proficiency is achieved with this, the system may apply an “eyes closed balance test.” This is a series of simple tests. It may be conducted to make sure the user is capable of safely standing with their eyes closed for a significant duration. This ability may not be built into the system as an assumption because any users without this capability may not be able to safely execute target hitting tasks with the eyes closed.

When the user has passed the eyes closed balance test, they may start with target hitting tasks with the eyes closed. These may be timed and users may be asked to hold their body segment on target (as close to the target as they are able) for a given period of time. Feedback may be given afterward to show them how close they were and in what direction they missed.

The user may end Phase 1 by doing basic target hitting while standing on one leg with the eyes open, for example.

### Phase 2—Medium

In this phase, corrective real time feedback is applied. The corrective arrow is intuitive and direct, so it may be the feedback that the user remains attentive to. Background color, background pattern, and sonification feedback may be associated to the corrective arrow information within this phase of training.

The first steps in Phase 2 are to apply real time feedback to the challenges from Phase 1 that the user is already used to. At this stage the eyes closed challenges may be skipped in an example, because the user uses the corrective arrow in order to assign meaning to the other real time feedback forms. In an example, Phase 2 starts with basic target hitting tasks with the eyes open and corrective real time feedback applied. The next step adds single-footed balance challenges in with the target hitting challenges. In this case, the challenges may have a set time within which the user gets as close as they may to hitting the target or may have unlimited time, but the challenge may stop when the user hits the target and holds for a short time.

As the user demonstrates proficiency with quickly moving to the target using corrective real time feedback, they may move on to target following challenges with different versions which include and do not include balance challenges.

Next, the system may determine that the user has the capability to begin using audio corrective feedback, which is one version of sonification of human movement. At this point, once the task is visibly demonstrated to them, the screen may cut off all visual feedback forms while they perform the task. A challenge of closing the eyes or not may be added here (closing the eyes does make things more difficult on balance and spatial awareness, so it is a further challenge beyond just cutting off visual feedback). In an example, the user may use the sonification information that they have associated with forms of corrective information to guide them to the target. Challenges that may be demanded here are a mix of target hitting, target following, and balance challenges.

Pose matching may be applied in this phase. During pose matching, corrective feedback is specific to one body segment at a time and the user may have awareness of which body segment the feedback is referring to. This may be done with a visual interface cue, so this may be done with the eyes open. Essentially, this amounts to target hitting using one body segment at a time as discussed above. Any form of corrective real time feedback may be selectively applied here.

### Phase 3—Complex

During Phase 3, many of the exercises from Phases 1 and 2 may be reviewed to continually reinforce learned skills. In an example, these may primarily be used during a “warm up” portion of a training session during Phase 3.

In an example, during Phase 3 the system may direct the user in a way to start building either generic or domain specific movement skills. Generic movement skills would be ones that are either especially well-suited to build proprioception, are movements that create a foundation for athleticism, or both. Looking at this entire process as a proprioception and feedback language intuition acquisition process, generic movement skills may be used. In an example, when the first stage of training is used for a certain movement domain (sport, dance, etc.), movements that are specific to that domain may be used during Phase 3.

In order to build these domain specific movements, the system may first use posing sequences. It may then move on to continuous movement matching after initial pose match exercises. Both of these more advanced exercises are described above.

There is another take on this scheme that stands out in that it has been conceived entirely as a domain specific process. Its goal is to lay general proprioception groundwork and build relatively quickly into domain specific training while reinforcing this proprioception development.

The plan for this type of domain specific proprioception skill acquisition acceleration is to use the following sequence, or a subset thereof, to establish the hidden skills that many athletes seem to have which allow them to pick up skills at a faster rate and with higher quality than others. The progression may then quickly morph that into domain specific training. Here is the scheme in, for example, a sequential order.

General Proprioception—touch on training as described above to develop proprioception in a non-specific sense.

Domain Proprioception—work on proprioception exercises that are specifically within the range of motion and position sequences of movements common to the domain.

Domain Posing—establish skill at getting into the body positions that are used for the movement skills of the domain.

Domain sequencing—develop skill at following a sequence of poses that match motions of the domain.

Flow for position—develop the ability to follow domain specific posing sequences in a continuous motion.

Flow for relative timing—develop the ability to match the movement of the domain with correct timing.

Speeding up—speed up these movements with correct timing, eventually speed execution.

Refinement—finish the series by making subtle corrections to converge to high efficiency movement.

There may be three variables that determine how rapidly a student may adjust to acquire new skills (note that “acquiring new skills” may be an all-encompassing phrase that covers acquisition of quality and automaticity and that to fully acquire a skill means to be able to reproduce it automatically with high quality technique).

One variable may be an inherent skill acquiring ability that may be the result of genetics or some accumulation of stimuli in early life. Another variable may be inertia or resistance to learning based on competing bad habits. Any habits that exist as movements which relate to the new skill may slow the acquisition of the new skill. The more well engrained these habits are, the more slowly the student may acquire the new skill. A third variable may be an athlete's desire and focus level with respect to making the change. The more sustained focus on the training that the athlete has, the more rapidly they may pick up the new skill.

The systems and methods described above may target the first variable. The systems and methods described above may compensate for any missed balance, coordination, or proprioception ability that did not come from genetics or early-life stimuli. In some cases a user may be doing these exercises with body positions and movements that are related to the discipline they are starting to train for. Domain specific proprioception (proprioception within the range of motion and movement sequences of the discipline) as a foundation of the learning process may speed up future skill acquisitions.

FIGS. 3A-3B illustrate corrective angles (FIG. 3A) and corrective arrows (FIG. 3B) in accordance with some examples.

The corrective arrow provides clear and concise information about the exact distance and direction the user moves in order to execute the technique correctly. As such it may be the foundation for building an understanding of the meaning behind the other types of real time feedback provided.

Further elaboration and description of the corrective arrow is included below. Initially, the corrective arrow may be implemented in a 3D display or in a 2D display. Because a 3D display conveys depth information automatically, many of the elements described here which are for the purpose of conveying depth information on a 2D display are redundant when implementing on a 3D display, however this redundancy may be useful in generating more rapid assimilation of the information even in the 3D display case.

Regardless of display type, a 3D representation of an arrow is formed by placing a cone on the end of cylinder such that the base of the cone adjoins to the end of the cylinder where the center of the base is lined up with the center of the end of the cylinder. In an example, the base of the cone may be a circle with about two times the radius of the circle which is at the end of the cylinder. Further the height of the cone may be about equal to the diameter of its base and the cylinder may be about 3 to 4 times as long as the height of the cone (though, the length of the cylinder may be variable so both the direction and distance of the intended correction may be conveyed). In an example, many alternative arrows may be constructed without changing the utility in this scheme. In a 3D display, this arrow may point in the direction that the body part you are focusing on moving, using the stereoscopic effect to convey cue information within the “depth” dimension.

In a 2D display the system may alter images in order to convey depth cues for rapid intuitive perception of the information it is built to convey. First, the system may use the idea of aspect ratio to convey to the user that some of the correction is to the left or right or up or down. The arrow may be shorter and the curved contours of the base of the cone and end of the cylinder tell the user that some of the correction may be forward or backward (where forward means toward the screen that is displaying the arrow and backward means away from the screen that is displaying the arrow). In an example, the front and back of the arrow may look distinctly different so that the arrow is intuitive as to whether the arrow is pointing into or out of the screen.

In an example, high contrast colors may be utilized to put markings in certain spots (for example, white for the bulk of the arrow and black for the markings). In an example, the black and white scheme may be used. First a black “x” may be placed on the front of the cone which forms the arrowhead such that the center of the “x” is at the point of the arrow and the arms of the “x” extend to the outer rim of the cone near the base. In an example, the base of the cone may be colored black. Finally, at the other end of the arrow, a dot may be placed in the center of the circle which forms the end of the cylinder portion of the arrow. This dot may be a black circle with a radius about ⅓ the radius of the base of the cylinder.

With this scheme, when the arrow is pointing right at the user, they may see it as a circle with an “x” in the center. When the arrow is pointing straight away from the user they may see a bullseye. And, when the arrow is pointed at an angle away or toward the user, they may see a significant portion of the “x” and no bullseye, or a minimized piece of the “x” and a skewed portion of the bullseye components where the outer rim of the bullseye is far at the opposite end of the arrow from the center dot. This additional cueing may make it instantly clear how the arrow is oriented with respect to all spatial dimensional degrees of freedom and, as such, create as rapid of feedback perception as possible.

In order to properly orient this arrow, a correction vector is calculated. Effectively, this vector is the difference between where the user's subject body segment is and where it may be according to a model that defines and ideal version of a technique (Note: Define “subject body segment” as the body segment that the real time feedback system is focusing on and providing information about). For motion capture technology, it is trivial to transform positional data specific to human body position back and forth between “joint angle data” and “body segment positioning data in 3D space”. Systems utilize joint angle data as a more efficient way to encode a movement with fewer data points. In an example, to calculate the correction vector, positioning in 3D space may be compared. As such, joint angle data may be transformed into body segment positioning data in 3D space. This is done by applying joint angles to a human body model and calculating the positions of body segments that result.

In order to make a relevant difference calculation, expert-model and user-model skeletons may be matched up in virtual space. In an example, the pelvis may not be the origin for this coordinate system, (x,y,z)=(0,0,0), but may be placed at the origin for both of the skeletal models. They would still need to be placed so they match up rotationally. To do this the system may establish three points which do not lie in a common plane on the model's pelvis and the user's pelvis (such that the position of the three points on one pelvis matches the position of the three points on the other pelvis) that may be held in fixed positions in the coordinate system. The positioning of the two may achieve a best match so that the two pelvises overlay one another nearly exactly.

Since the feedback is generated in real time, the user may not be well versed in the timing of the technique so they may not be effective in doing the correct action at the correct time. Dealing with this amounts to a preparation task. The system may prepare the user with several visual examples of the timing prior to a first attempt and at least one demonstration every certain number of attempts (say 6) after that.

Finally, the vector which defines the position of the user's subject body segment may be subtracted from the vector which defines the position of the ideal model's subject body segment to give the correction vector. The direction of the correction vector may be mapped to the correction arrow and the correction arrow may display the direction of the correction as seen from the user's perspective. Displaying it to match the user's perspective uses the coordinate system of display area (screen, or virtual space in the case of a head mounted device) in which the correction arrow “lives” and requires a rotation to generate the right direction to display the corrective arrow from the direction it had within the coordinate system where the correction vector is calculated.

A vector contains direction and magnitude. Magnitude is the size of the vector, or the distance it covers from its start point to its end point. If the user's subject body segment is close to the ideal model's subject body segment, this vector may have a small magnitude matching the small correction. It is clear then that this magnitude information is very useful as well. The magnitude could be conveyed on the correction arrow in a couple of ways. First, the correction arrow could be shortened or elongated to match the nature of the vector. Second, it could have its color pattern change (still using high contrast between arrow overall color and markings color) to convey magnitude.

It is worth noting that the calculation of the correction vector is useful for correctional real time feedback. The magnitude or direction of this vector may be conveyed in sonification, background color, or the background pattern. In order to generate each one, a transformation would be applied that would take the correction vector as input and output values that would define the sound, color, or shapes represented in sonification, background color, or background pattern respectively.

In an example, corrective real time feedback of this type may not be useful at full speed execution of technique. The expected use case for corrective real time feedback may be in various levels of slow motion execution. This is not to rule out the possibility that a user may not incorporate real time feedback during full speed execution of a technique, but the expectation is for that to be the exception, not the rule.

It is also worth considering that real time corrective feedback at full speed technique execution may work very well for cyclical techniques. Further, as discussed throughout this disclosure, adaptations of discrete techniques to make them cyclical may add significant utility to real time corrective feedback training and allow for nearer full speed execution exercises.

At each stage of learning a new technique there are challenges that may not likely be present in the other stages.

Early on, via a mix of demonstration, instruction and attempts with delayed feedback, the user learns the “rules” of the movement. They gain an understanding of the components of the movement and how they fit and flow together. They also gain some neural circuitry which may be relied upon to produce the movement.

At a mid-stage in the process, they have a handle on the rules, but they struggle to get their body to conform to these rules. Over many attempts with feedback they build a neurological system that may generally match the movement when they are focusing on the action of the movement, but not so reliably when focused on something else.

At a late-stage, they are working toward high quality automatic execution while refining to eliminate increasingly trivial mistakes.

### Early

In the early stage, users' limited attention and focus are largely fully utilized for simply exploring how their body responds to motion roughly matching the model of technique which has been conveyed to them. It is expected that little bandwidth is left over for additional learning.

As such, it is better at this point to provide feedback after user attempts. So, at this point in learning, feedback may be delayed corrective feedback.

Note: It may be assumed that in many cases, users may already have some intuitive understanding of these real time feedback “languages” because the assumption is that this process may be used each time a new technique is attempted.

### Mid

In the mid stage, users have some ability to execute something resembling correct technique somewhat automatically and have a good model built in their head. This means the cognitive load used by the user to produce the movement may drop over time. As such they may be able to redirect their attention to focus on audio feedback during technique execution. That fact and the fact that at this stage, they have built some context about the movements means they may make good use of corrective real-time feedback.

This stage may be the longest of the 3 in an example, as its value may simply cover more of the chronological learning time for a new technique. This may be true when this is a technique that may not actually be used in a performance stage, but is useful in training as an exercise to help learn a more complex technique that would be used in performance.

### Late

In this stage the user is quite close to correct execution, but may benefit from more reps toward increased automaticity and additional subtle nudges toward higher efficiency.

For “final” techniques or “target” techniques, where the user may perform their exact motion as a driver of excellence in their discipline, the user may not be moving away from training this technique. It would be something the user may revisit throughout their time with the discipline. In this case, the late stage would be drastically longer than the early or mid-stages.

There is limited cost and significant advantage to adding in and using delayed corrective feedback during the mid and late stages of this process. It is just that it may be used less and less as they get better at the technique, better at interpreting real time feedback, and better at self-analyzing with task-specific proprioception. So, in the mid stage delayed corrective feedback may be used, for example, roughly once every 5 reps to start and once every 10 reps near the end. In the late stage maybe delayed corrective feedback would be used once every 15 reps at the beginning and once every 25 reps at the end.

Another consideration is that the transition between the 2^{nd} stage and the 3^{rd} stage may be blurred. During this blurring, both types of real time feedback may be used. In fact, this may persist throughout the 3^{rd} stage to some degree. In an example, it is expected that a system may use convergent real time feedback as the main focus in the final stage.

The system is designed to accommodate and leverage the human brain's attentional spotlight. The attentional spotlight is labeled as a spotlight because it is a specific singular focus area. This may be a concern in training situations. For human learning, in general, this attentional spotlight focus is on producing the outcome that has been demanded. Further, an outcome may be demanded from a “training situation” in many ways. To provide examples, here are some common training situations that demand certain outcomes.

In a game, the desired outcome of any given encounter is to increase a chance or a team's chance to win. This typically leaves a player with little time to think about technique. Even when there is time to think about technique it is not possible to think about a significant number of technique details. As such this is a poor environment in which to train toward technique improvement as it demands a “game utility” focus.

Individual training without a coach is often focused on the athlete's perceived in-game utility for the action they are working on. As a result, self-directed individual training typically demands a “results” orientation, in an example, thinking about technique, the user thinks about things like velocity, accuracy, and other aspects they have been told are good results to shoot for with a given technique.

In an example, an exception may include weight training (e.g., strength or power development training), where the motion being practiced is not specific to the sport or discipline they are training for, but they know that added strength may help. In an example, this user would focus on the “outcome” of moving against the resistance as the exercise is designed as opposed to the technique details of the exercise.

In an example, an exception may include “enlightened” students who have been taught the importance of technique focus and how to do this. These students may work on technique in a self-directed way (in both the weight room and domain specific skill development).

Another example training situation is private lessons. When a private lesson is technique focused this means that the instructor has actually created a situation where the goal of the movement is correct technique and not some other outcome-based goal. Their focus may be on one technique detail at a time, and effective training may cycle through technique details over a series of repetitions to ensure each is being addressed.

With this system the private lesson condition above may be emulated. For example, the user's attention may be directed to technique. In an example, technique correction may be efficient when the user focuses on one correction at a time. Errors usually involve a body segment and a portion of time within the technique. Correcting one error at a time means focusing on that segment during the time sequence within the technique's total time where the error occurred. In an example, that focus may be retained until that error has improved. Other, slightly more complicated, corrections are possible as well without overloading the attention system, and the single body segment for a short time period example is the best for this discussion.

Ensuring the user's mind makes a parallel adjustment such that it is focused on the same detail may include using a display device dependent technique. One example device is a traditional television, computer, phone, or tablet screen. Another is an immersive head mounted display such as virtual reality (VR) or immersive augmented reality (AR) (e.g., immersive AR includes “headset” AR where the user perceives the real world with three-dimensional virtual objects layered on top the real world). In both cases, there may be a user option condition and a progression dictated condition.

In an example, a visual representation of the specific body area in question may be displayed in a portion of the viewing area. The user may be directed to look at this visual representation. This visual representation may be a zoomed in view of the body segment whose motion they are working on correcting.

Visual feedback (e.g., background color, background pattern, corrective arrow, or a combination thereof) may exist elsewhere on the screen, but, to avoid having it distract and pull the eyes away, it may be noticeable and intense in the area immediately surrounding this body segment visualization. In an example, given an estimated viewing distance from a computer screen (in a case where a computer screen is used this “intense” area may include an area less comprising than 1.5 degrees of field of view from the visualization of the body segment, such as radially or on all sides, such that it may exist within the user's fovea for sharp attentive vision. Finally, this visualization of the body segment may move via skeletal tracking to remain oriented as the user's body segment is oriented during the technique movement via the skeletal tracking system.

In the case of user option to select from a menu, the user may be presented with a visual representation of several body segment options with descriptions below to explain what technique detail it represents so they may work on the one they want. For the traditional screen version, they may select their desired option with a click, screen tap, scroll over, or gesture that is recognizable via skeletal tracking. For the immersive head mounted display version, they may move their head to put a reticle (crosshairs), dot, or other visual rendered in the center of their vision over the technique detail they want to work on and use a gesture or click with a hand held device to make the selection. This selection method has been commonly used in head mounted displays and works like a mouse pointer on a traditional computer display.

After selecting, the other options may fade out and they may begin to work on the selected detail. Other graphics may fade in as well, such as a background color and pattern. The still shots presented for selection may be specific to a single technique. This user choice condition would be used once the player has worked through the progression far enough that they have “earned” the right to choose what detail to work on.

In the Progression Directed condition, the user may be presented a technique detail in a similar fashion to what is described above, without being shown an array of choices. They may simply use a similar mechanism as described above to begin. An alternative to “selecting” the visual representation of the technique detail in a similar fashion as described above would be to have buttons below the still shot of the technique detail which allow them to review what to do, go back to the main menu, or begin training.

By using this selection system and then displaying the body segment in question as the primary on screen visual, the correct focus on the technique adjustment that the system is set to measure may be ensured. Optimal training with respect to rate of improvement may be thus presented.

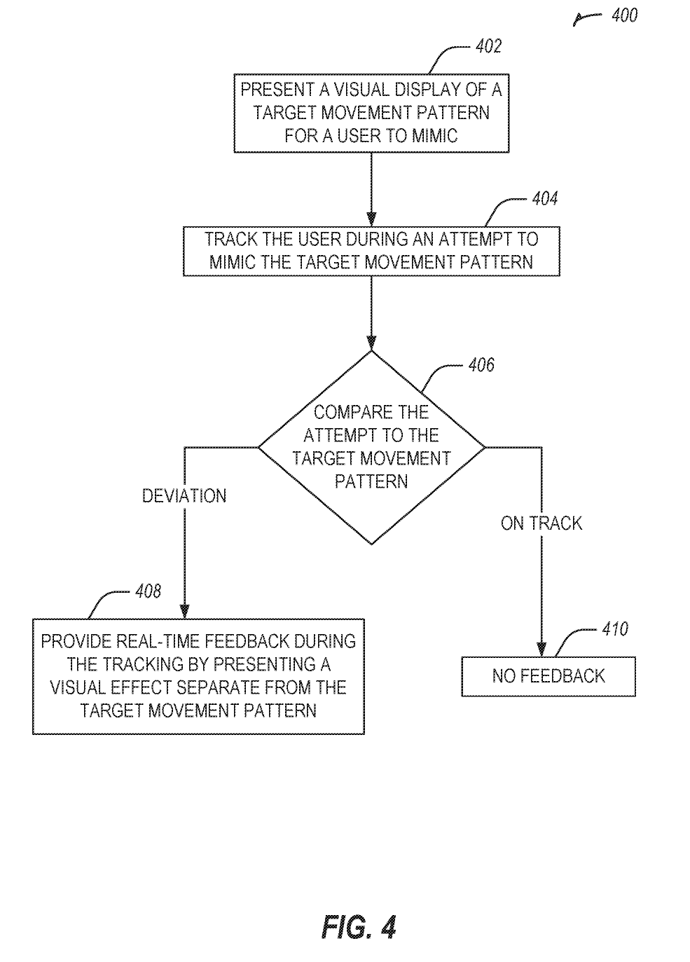

FIG. 4 illustrates a flowchart showing a technique 400 for provide coaching feedback in accordance with some examples.

The technique 400 includes an operation 402 to present a visual display of a target movement pattern for a user to mimic. The target movement pattern may include a benchmark spatial path. Operation 402 may include generating a 3D model of the target movement pattern and displaying the 3D model, such as using an immersive headset, within a 3D environment around the user. Operation 402 may include displaying a 3D target within the 3D environment for the user to move a specified body part to during the attempt. The target may be a moving target configured to be presented as moving throughout the attempt or a portion of the attempt. Before the attempt to mimic the target movement pattern, a target may be presented for the user to hit during the attempt. The target may be removed from view before the user begins the attempt. In an example, the visual display of the target movement pattern may be instantiated by a visual skeletal 3D model overlaid on the user.

The technique 400 includes an operation 404 to track the user during an attempt to mimic the target movement pattern. The attempt may include a trial spatial path. Similar to a benchmark spatial path, a trail spatial path is the path or set of points in space of a user's body part. The body part may be a joint, hand, arm, leg, waist, etc. The technique 400 includes a decision operation 406 to compare the trial spatial path to the benchmark spatial path.

The technique 400 includes an operation 408 to, when deviation is determined between the trial spatial path and the benchmark spatial path, real-time feedback during the tracking is provided by presenting a visual effect separate from the target movement pattern. The visual effect may indicate a deviation of the attempt from the target movement pattern based on the comparison, in an example, audible language may be avoided (not used) when providing the real-time feedback. Operation 408 may include playing a sound, the sound representing a change to be made by the user to align the attempt to the target movement pattern (e,g., tempo, direction, etc.). The sound may include a dynamic center of frequency between 2000 Hz and 5000 Hz in an example. In an example, the visual effect indicates a change to be made to align the attempt to the target movement pattern. The visual effect may include a change to a background color, a change to a background pattern, a corrective arrow, or the like. These may correspond to the change to be made to align the attempt to the target movement pattern.

The technique 400 includes an operation 410 to provide no change in feedback (or no feedback) when the attempt does not deviate from the target movement pattern the comparison indicates no deviation).

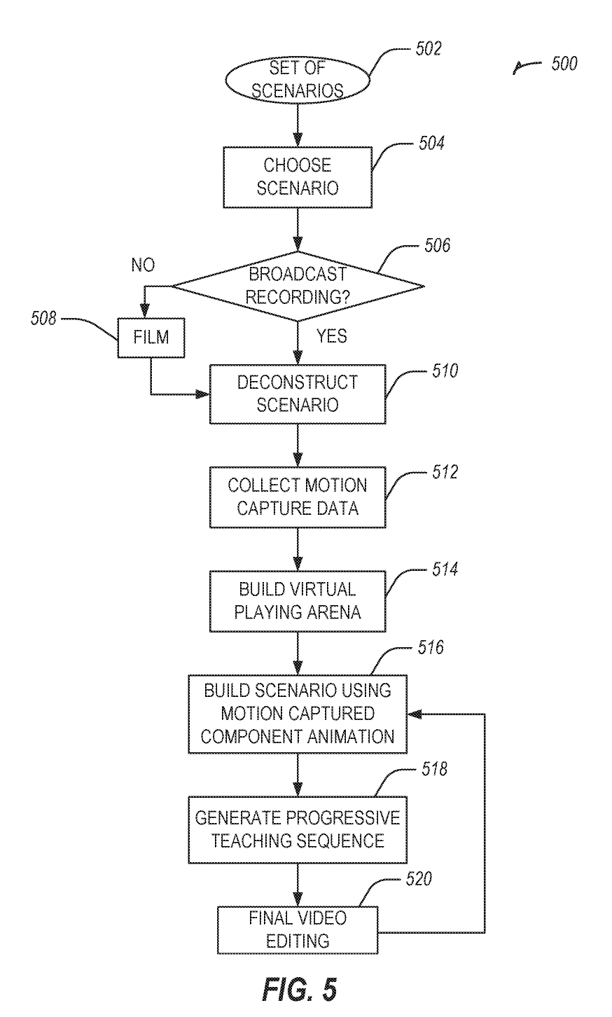

FIG. 5 illustrates a flowchart showing a technique 500 for building an animation scenario in accordance with some examples. The technique 500 includes a set of scenarios for selection 502. The set of scenarios 502 may be selected for a given sport or discipline.

The technique 500 includes an operation 504 to choose a scenario to build in animation.

The technique 500 includes an operation 506 to determine whether the scenario includes film from a broadcast recording.

The technique 500 includes an operation 508 to generate film when no broadcast recording is available. A minimum number of cuts, maximum scope of shots, or quality may be determining factors for generating film.

The technique 500 includes an operation 510 to deconstruct the scenario into component parts which fit into a motion capture area.

The technique 500 includes an operation 512 to collect motion capture data.

The technique 500 includes an operation 514 to build a virtual playing arena.

The technique 500 includes an operation 516 to build the scenario in animation using motion captured component animation. Components of the animation may be pieced together in a correct sequence to create a continuous animation of the scenario. In an example, decision options or sensory clues may be identified in the animation.

The technique 500 includes an operation 518 to generate a progressive teaching sequence. Operation 518 may include moving virtual lighting or virtual cameras to render the scenario many different times to cover different decision examples or visual cues that may be needed or used to teach the scenario. The decision options may be ordered into a progressive teaching sequence.

The technique 500 includes an operation 520 to perform final video editing. Final editing may include sequence editing to match a teaching progression. Freeze frames or motion graphics may be added to assist in teaching visual clues. The technique 500 may include returning to operation 516 to add additional progressions or scenarios.

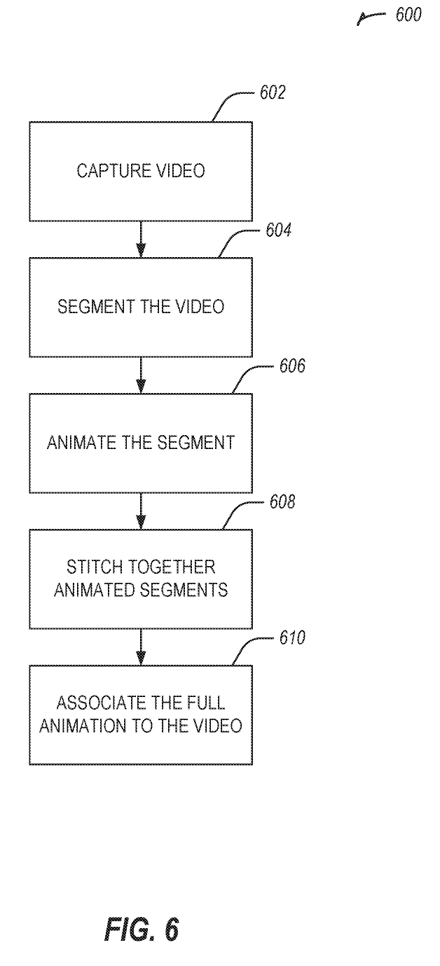

FIG. 6 illustrates a flowchart showing a technique 600 for animation of video segments in accordance with some examples.

The technique 600 includes an operation 602 to capture video.

The technique 600 includes an operation 604 to segment the video.

The technique 600 includes an operation 606 to animate the segment.

The technique 600 includes an operation 608 to stitch together animated segments.

The technique 600 includes an operation 610 to associate the full animation to the video.

Gravity, inertia, and the cost of human labor are major limitations when it comes to producing live videos. The cost of human labor is also a major challenge when it comes to producing animation, but adjusting lighting, camera positions, sets, wardrobes, and more makes additional shots of live video a major deployment of resources as compared to additional shots of the same or similar content in 3D animation.

In an example, a system produces sports scenarios to teach users how to read and react to dynamic sports situations. In an example, focus may be applied many specific events that happen in types of plays that are being taught, for example, the various opportunities to take in visual information to make a decision. As such, once a scenario has been set, the camera may be moved around to many different locations and perspectives within the scenario to provide example visual cues. The camera may be moved to show the full scope of the action of the play as well as individual response action options based on the visual cues. As such, a scenario may feature many repetitions of the same sets of movements for the actors.

When this is done in 3D animation, the scenario may be set up once and then rendered multiple times to show views of the action playing out, visual cues, and a variety built-in to keep repetitions fresh. 3D animation is very much emerging in recent years as computer technology may now handle the computation to create near photo-realistic animation in virtual environments. This makes it a perfect time to launch an animation-based technique for teaching athletes the ins and outs of sports scenarios to train rapid and high quality decision making.

The systems described herein may be used to allow for the creation of a process that facilitates the building of large scale sports scenarios in animation, despite the traditional inability to do so.

The first step is to use video analysis to create maps of player location and sporting implement location (ball, puck, etc.) on the sport's field. These may include the timing of motion which is central to the concept of recreating a scenario. The video itself contains information about what techniques were used by each player at each stage of the scenario.

With that set of information, a set of sub-scenarios may be created which themselves may be captured in a reasonably sized motion capture studio. Some of these may use the inclusion of multiple players in a small space within the motion capture area. Others may use one player at a time to be captured.

The motion capture studio may be sized to handle the largest sub-scenario that the larger scenario is broken into.

The large scenario may be sufficiently broken into sub-scenarios such that each one may be fit into the motion capture studio.

Toward the effort of reconstructing the scenario, effectively, a sub-scenario becomes a “shot” in the corresponding motion capture studio “shot-list”. Then, one by one, a sub-scenario may be captured. Then a captured sub-scenario may represent something like building blocks in the effort to reconstruct the scenario.

In an example, passable experts may be used to perform the techniques involved in the scenario. In an example, decision making may be taught within each scenario as opposed to demonstration of perfect technique. These decisions may mean selecting a certain technique over another (as in hockey, where a hard pass, a soft area pass, or a saucer pass may be chosen . . . or where a slap shot, snap shot, or pull-snap shot may be chosen). In an example, the resulting scenario may look “expert”, and yet it may not require the inclusion of highly refined versions of the techniques.

The next step is to construct a digital version of the sports field within which the scenario had played out. In an example, it may have the right dimensions relative to the size of the animated players.

Finally, an animator may start stringing together the motion captured sub-scenarios within this virtual sports field. There may be two challenges which stand out when doing this. The first is to utilize the video and map of the original video as a guide to allow replication and reconstruction of the physical nature of the play with identical timing to the original. The second is to accurately recreate the motion of the sporting implement as it played out within the original scenario as this may not be built into the captured sub-segments. It may be up to the animator to use the motion-captured sub-scenarios and the original reference video of the scenario to create a smooth “whole” version of the technique with the ball or puck placed in the right place frame by frame such that it matches the reference video.

Once the scene is correct, then it is broken into teaching cues with whatever virtual camera perspective, sequencing, motion speeds, and motion graphics overlays are used to present the visual cues that may really have driven players' decisions in the plays in which the scenario has played out in the past, the options a player had, and what was the correct decision. Then the same scenario may be rendered many times with variety.

The original scenario may be created on a real field and videoed as part of the production process, or taken from a real sports broadcast and then recreated in this way. In either case, if it helps teaching, the play may be adjusted to be “even more perfect than reality” for teaching the read and react.

Also, before capturing the sub-scenarios, other ways that the play may have played out may be considered. A map of player motions may be constructed based on how the play may go in an idealized case or decisions on the technique choices. Once this is done, this scenario may be fed through the same sequence described above where the scenario is broken into sub-scenarios, those scenarios are then captured, and so on. Then, one may consider once again how it may have played out differently if a different decision was made based on different visual cues. Then each possible sequence of events may be captured and assembled as described above. In this way, complete teaching may be done including reading cues that, by the nature of what is seen, drive either/or decisions as far as the choice of best strategy for a given scenario.

The full scope of this method may drive the cost of production for scenario systems significantly downward via the efficiencies of producing one scene in animation and shooting it virtually from many different angles without actually having to get more than one human being involved in moving the virtual cameras into new positions.

A time of flight depth camera may be used to keep track of solid objects in view by measuring for solid objects within a three dimensional “point cloud” which sits in the depth camera's field of view. The depth camera determines the location of these solid objects with respect to the points in the point cloud by sending out structured light to probe the locations of the points in the point cloud. When that structured light returns, it measures the time that it took for the light to return. In this way it understands both the direction and the depth of the solid object that the light actually hit before returning to the sensor.

For a given “frame”, once the sensor has decided on the locations of physical objects that are present in the point cloud, that pattern may then be used to infer what it actually was that the structured light hit. In an example, it may use the pattern to decide on what it is that it is “seeing”.

An infrared camera may be used to track the skeletal position of human beings within the point cloud. When the system was programmed understand “human” shaped patterns in the point cloud, the programmers had the choice of attempting to directly code a pattern analysis system that may account for the myriad possibilities which may be a human being and be presented to the sensor as a point cloud pattern or use supervised machine learning which correlates point cloud patterns to human skeletal locations as “training data”.

They chose the second option and had people do two jobs with respect to creating training data. The first job includes standing in the point cloud and allowing the system to produce point cloud patterns from their body positions. The second job is much more tedious for a human. A separate person (although it may have been the same person) went in and a correlated data set which defined where that human skeleton had been positioned within that point cloud for each recorded “frame.” In an example, 150,000 frames are used to create the machine learned technique which drives an infrared camera system skeletal tracking.

With only one sensor (which is a combination of a structured light emitter and a receiver) it has no redundancy in terms of point of view and may lose track of body parts which are line-of-sight behind other objects in the point cloud.

The previously mentioned infrared camera system is machine-learning trained to track the human body without additional implements in the hands or on the body other than common clothes. In an example, things like hockey sticks and baseball bats may be problematic.

To solve these problems, a single sensor system may be used that features two depth cameras. This may create redundancy in the point of view and eliminate occlusion in many cases.

This document speaks to a very rapid and efficient way to do just that. In an example, this may be called Motion Capture Laboratory Assisted. Machine Learning.

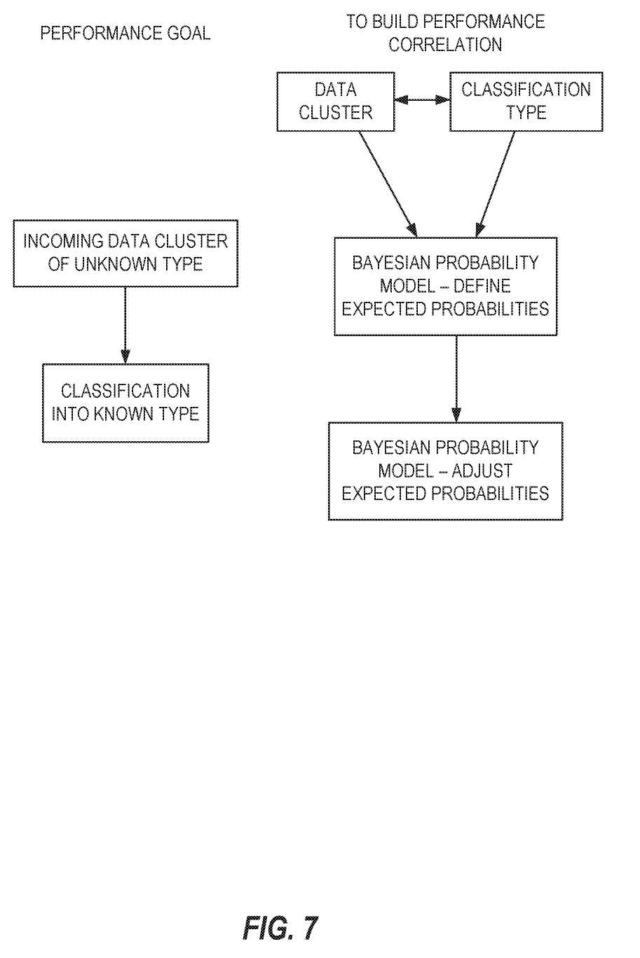

FIG. 7 illustrates a block diagram for supervised machine learning training in accordance with some examples.

Using a dual depth camera hardware a system may enable precise skeletal tracking in divergent situations with variables ranging from body type, clothing choices, and, in a typically problematic example, sports specific object inclusion. To overcome this, a system may use machine learning to develop code which may accommodate these issues while achieving precise skeletal tracking.

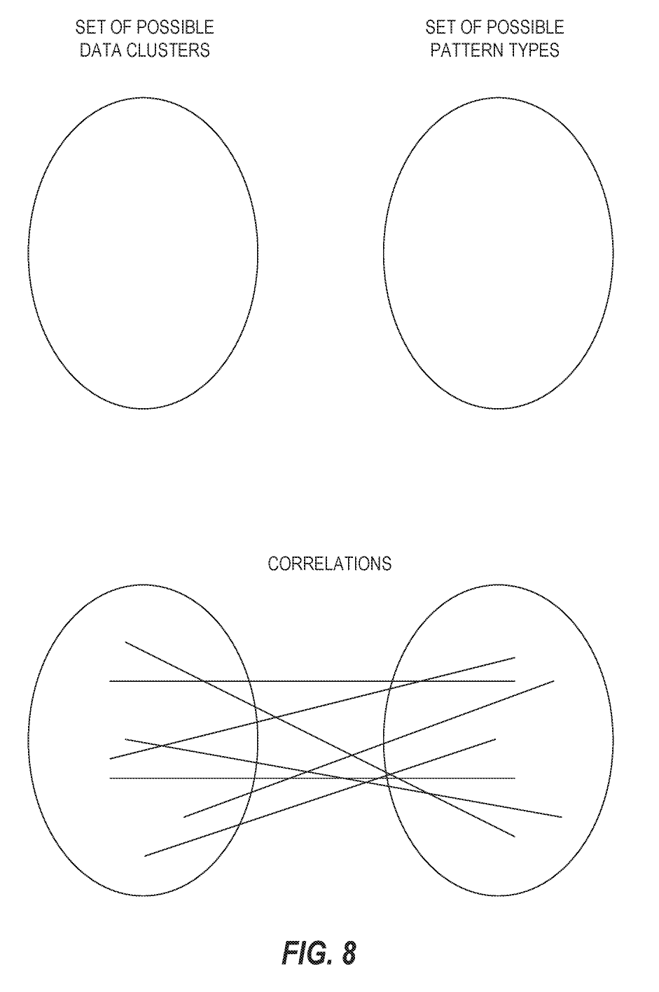

FIG. 8 illustrates data correlation graphs in accordance with some examples.

Machine learning comes in two main categories:

Supervised—In Supervised Machine learning, a person designs “training” for the machine by feeding data into a computer and then providing the “pattern” which that data represents. With enough training data of this type, the machine learns the telltale signs for a possible configuration of the types of patterns it has been shown and becomes very good at identifying desired output patterns with high detail and precision.

Unsupervised—Unsupervised Machine learning looks for deviations from randomness in the distribution of data it is given. These deviations are called clustering. It also looks for correlation patterns in structured data. Structured data is, in an abstract sense, a type of data where component characteristics may be grouped together in ordered vectors of the following type (x₁, x₂, x₃, . . . xₙ) where xₐ represents a quantification of a certain aspect of the elements which the data describes for elements in the data set. As a result, correlations emerge when a certain variance pattern of xₐ frequently coincides with a variance pattern of x_{b} where xₐ and x_{b} may be any of the coordinates in the vector. Once these clusters and correlations are detected, they may be utilized to help detect phenomena that fit into the same categories in the future. In this case the correlations and clusters looked for may be related to the skeletal positioning of the user.

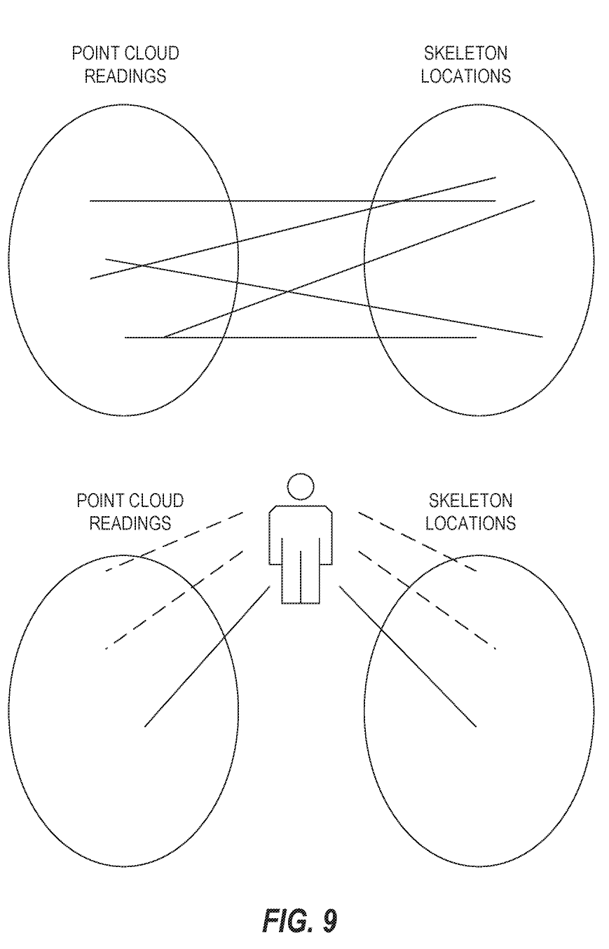

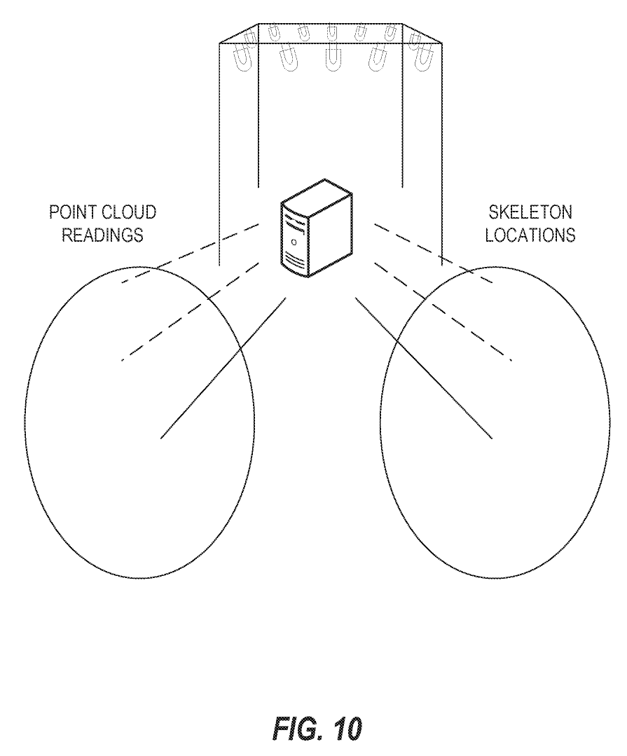

FIG. 9 illustrates a graph showing a first technique for skeleton recognition in accordance with some examples. FIG. 10 illustrates a graph showing a second technique for skeleton recognition in accordance with some examples.

The type of Machine Learning used in this system uses a Motion Capture Laboratory as the training agent in Supervised Machine Learning. One way to think about it is that two computerized sensor systems comprising usually separate components may be combined together to form the data set inputs for a 3^{rd} component which is a Neural Network type Machine Learning array in a “self-supervising” machine learning process. Another way to look at it is to say that this is a typical Supervised Machine Learning set up but where the human “supervisor” is assisted by the Motion Capture Laboratory in the Supervision process. Either way you look at it, the purpose here is rapid accumulation of Supervised Learning training data.

The concept is to use a motion capture facility designed for the precision uses of life sciences or video animation motion capture to track a human skeleton while a person performs a wide range of moves. At the same time, the depth-camera-based sensor system may read the point cloud information that the person is creating within the sensor's field of view. Then for a frame within the point cloud readings captured at a given instant in time, the high precision motion capture system may feed the skeletal tracked pattern which was captured at the same time to the machine learning array so that it may learn to correlate the patterns of each data type together. This method may be used with a lot of different sporting implements on the body or in the hands, a lot of different body types, and with clothing which may reflect the structured light from the depth camera, but still allow the motion capture laboratory cameras to see tracked markers positioned underneath clothes on the body or on compression clothing.

In an example, this system may use 1,000,000 frames to learn to correlate skeletal locations for point cloud readings in all of the possible situations. When the depth cameras operate at 60 frames per second, then that many frames may be achieved over the course of 5 hours of continuous shooting. Considerations such as combinations of different sporting implements, body types, clothing types, and movements may like extend that 5 hours of continuous shooting over a month or more to get the factors considered. Also, quality control on sensor performance on both ends (depth cameras and Motion Capture Laboratory cameras) may use checking to ensure bad data is not fed back to the Machine Learning Array.

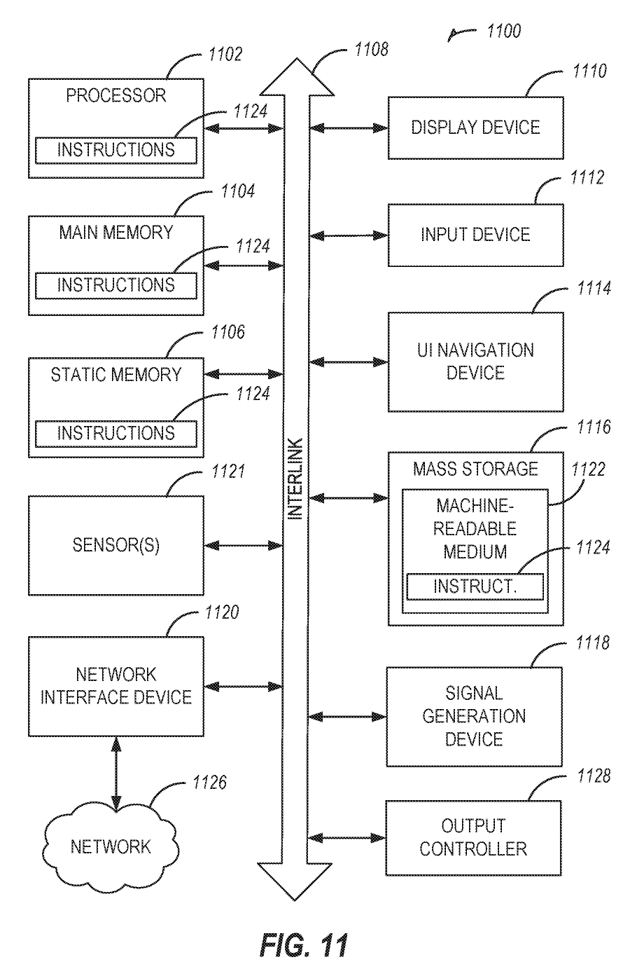

FIG. 11 illustrates a block diagram of an example machine 1100 upon which any one or more of the techniques discussed herein may perform in accordance with some embodiments. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine readable medium 1122 on which stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124. The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MEMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software.

Example 1 is a method comprising: presenting a visual display of a target movement pattern for a user to mimic, the target movement pattern including a benchmark spatial path; tracking, using a sensor, the user during an attempt to mimic the target movement pattern, the attempt including a trial spatial path; evaluating a comparison between the trial spatial path to the benchmark spatial path; and providing real-time feedback during the tracking by presenting a visual effect separate from the target movement pattern, the visual effect indicating a deviation of the attempt from the target movement pattern based on the comparison.

In Example 2, the subject matter of Example 1 includes, wherein presenting the visual display includes: generating a three-dimensional model of the target movement pattern; and displaying the three-dimensional model, using an immersive headset, within a three-dimensional environment around the user.

In Example 3, the subject matter of Example 2 includes, wherein the presenting the visual display includes presenting a three-dimensional target within the three-dimensional environment for the user to move a specified body part to during the attempt.

In Example 4, the subject matter of Example 3 includes, wherein the three-dimensional target is a moving target configured to be presented as moving throughout the attempt.

In Example 5, the subject matter of Examples 1-4 includes, wherein audible language is not used when providing the real-time feedback,

In Example 6, the subject matter of Examples 1-5 includes, wherein providing the real-time feedback includes playing a sound, the sound representing a change to be made to align the attempt to the target movement pattern.

In Example 7, the subject matter of Example 6 includes, Hz.

In Example 8, the subject matter of Examples 1-7 includes, presenting, before the attempt to mimic the target movement pattern, a target for the user to hit during the attempt, and removing the target from view before the user begins the attempt.

In Example 9, the subject matter of Examples 1-8 includes, wherein the visual effect indicates a change to be made to align the attempt to the target movement pattern.

In Example 10, the subject matter of Example 9 includes, wherein the visual effect includes a change to a background color, a change to a background pattern, or a corrective arrow, corresponding to the change to be made to align the attempt to the target movement pattern.

In Example 11, the subject matter of Examples 1-10 includes, wherein the visual display of the target movement pattern is instantiated by a visual skeletal three-dimensional model overlaid on the user.

Example 12 is a non-transitory machine-readable medium including instructions, which when executed by a processor, cause the processor to perform operations to: send, to a display for presentation, a visual display of a target movement pattern for a user to mimic, the target movement pattern including a benchmark spatial path; track, using data received from a sensor, the user during an attempt to mimic the target movement pattern, the attempt including a trial spatial path; evaluate a comparison between the trial spatial path to the benchmark spatial path; and provide real-time feedback during the tracking by sending, to the display for presentation, a visual effect separate from the target movement pattern, the visual effect indicating a deviation of the attempt from the target movement pattern based on the comparison.

In Example 13, the subject matter of Example 12 includes, wherein to send the visual display for presentation, includes: generating a three-dimensional model of the target movement pattern; and sending the three-dimensional model for presentation within a three-dimensional environment around the user, wherein the display is an immersive headset.

In Example 14, the subject matter of Example 13 includes, wherein to send the visual display includes sending a three-dimensional target within the three-dimensional environment for the user to move a specified body part to during the attempt.

In Example 15, the subject matter of Examples 12-14 includes, wherein to provide the real-time feedback, the processor is further to play a sound, the sound representing a change to be made to align the attempt to the target movement pattern.

In Example 16, the subject matter of Examples 12-15 includes, wherein the visual effect indicates a change to be made to align the attempt to the target movement pattern.

In Example 17, the subject matter of Example 16 includes, wherein the visual effect includes a change to a background color, a change to a background pattern, or a corrective arrow, corresponding to the change to be made to align the attempt to the target movement pattern.

Example 18 is a system comprising: a display to present a visual display of a target movement pattern for a user to mimic, the target movement pattern including a benchmark spatial path; a processor to: track, using data received from a sensor, the user during an attempt to mimic the target movement pattern, the attempt including a trial spatial path; evaluate a comparison between the trial spatial path to the benchmark spatial path; and provide real-time feedback during the tracking by sending, to the display for presentation, a visual effect separate from the target movement pattern, the visual effect indicating a deviation of the attempt from the target movement pattern based on the comparison.

In Example 19, the subject matter of Example 18 includes, wherein the processor is further to generate a three-dimensional model of the target movement pattern; and wherein to present the visual display, the display is further to present the three-dimensional model within a three-dimensional environment around the user, wherein the display is an immersive headset.

In Example 20, the subject matter of Example 19 includes, wherein to present the visual display, the display is further to present a three-dimensional target within the three-dimensional environment for the user to move a specified body part to during the attempt.

Example 21 is a method comprising: presenting a visual display of a target movement pattern for a user to mimic, the target movement pattern including a benchmark spatial path; tracking, using a sensor, the user during an attempt to mimic the target movement pattern, the attempt including a trial spatial path; evaluating a comparison between the trial spatial path to the benchmark spatial path; and providing real-time feedback during the tracking by playing a sound, the sound representing a change to be made to align the attempt to the target movement pattern.

In Example 22, the subject matter of Example 21 includes, Hz.

In Example 23, the subject matter of Examples 21-22 includes, presenting, before the attempt to mimic the target movement pattern, a target for the user to hit during the attempt, and removing the target from view before the user begins the attempt.

Example 24 is a system comprising: a display to present a visual display of a target movement pattern for a user to mimic, the target movement pattern including a benchmark spatial path; a processor to: track, using data received from a sensor, the user during an attempt to mimic the target movement pattern, the attempt including a trial spatial path; evaluate a comparison between the trial spatial path to the benchmark spatial path; and provide real-time feedback during the tracking by playing a sound, the sound representing a change to be made to align the attempt to the target movement pattern.

In Example 25, the subject matter of Example 24 includes, Hz.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
presenting a visual display of a target movement pattern for a user to mimic, the target movement pattern including a benchmark spatial path;
tracking, using a sensor, the user during an attempt to mimic the target movement pattern, the attempt including a trial spatial path;
evaluating a comparison between the trial spatial path to the benchmark spatial path; and
providing real-time feedback during the tracking by presenting a visual effect separate from the target movement pattern, the visual effect indicating a deviation of the attempt from the target movement pattern based on the comparison.

2. The method of claim 1, wherein presenting the visual display includes:
generating a three-dimensional model of the target movement pattern; and
displaying the three-dimensional model, using an immersive headset, within a three-dimensional environment around the user.

3. The method of claim 2, wherein the presenting the visual display includes presenting a three-dimensional target within the three-dimensional environment for the user to move a specified body part to during the attempt.

4. The method of claim 3, wherein the three-dimensional target is a moving target configured to be presented as moving throughout the attempt.

5. The method of claim 1, wherein audible language is not used when providing the real-time feedback.

6. The method of claim 1, wherein providing the real-time feedback includes playing a sound, the sound representing a change to be made to align the attempt to the target movement pattern.

7. The method of claim 6, wherein the sound includes a dynamic center of frequency between 2000 Hz and 5000 Hz.

8. The method of claim 1, further comprising presenting, before the attempt to mimic the target movement pattern, a target for the user to hit during the attempt, and removing the target from view before the user begins the attempt.

9. The method of claim 1, wherein the visual effect indicates a change to be made to align the attempt to the target movement pattern.

10. The method of claim 9, wherein the visual effect includes a change to a background color, a change to a background pattern, or a corrective arrow, corresponding to the change to be made to align the attempt to the target movement pattern.

11. The method of claim 1, wherein the visual display of the target movement pattern is instantiated by a visual skeletal three-dimensional model overlaid on the user.

12. A non-transitory machine-readable medium including instructions, which when executed by a processor, cause the processor to perform operations to:
send, to a display for presentation, a visual display of a target movement pattern for a user to mimic, the target movement pattern including a benchmark spatial path;
track, using data received from a sensor, the user during an attempt to mimic the target movement pattern, the attempt including a trial spatial path;
evaluate a comparison between the trial spatial path to the benchmark spatial path; and
provide real-time feedback during the tracking by sending, to the display for presentation, a visual effect separate from the target movement pattern, the visual effect indicating a deviation of the attempt from the target movement pattern based on the comparison.

13. The machine-readable medium of claim 12, wherein to send the visual display for presentation, includes:
generating a three-dimensional model of the target movement pattern; and
sending the three-dimensional model for presentation within a three-dimensional environment around the user, wherein the display is an immersive headset.

14. The machine-readable medium of claim 13, wherein to send the visual display includes sending a three-dimensional target within the three-dimensional environment for the user to move a specified body part to during the attempt.

15. The machine-readable medium of claim 12, wherein to provide the real-time feedback, the processor is further to play a sound, the sound representing a change to be made to align the attempt to the target movement pattern.

16. The machine-readable medium of claim 12, wherein the visual effect indicates a change to be made to align the attempt to the target movement pattern.

17. The machine-readable medium of claim 16, wherein the visual effect includes a change to a background color, a change to a background pattern, or a corrective arrow, corresponding to the change to be made to align the attempt to the target movement pattern.

18. A system comprising:
a display to present a visual display of a target movement pattern for a user to mimic, the target movement pattern including a benchmark spatial path;
a processor to:
track, using data received from a sensor, the user during an attempt to mimic the target movement pattern, the attempt including a trial spatial path;
evaluate a comparison between the trial spatial path to the benchmark spatial path; and
provide real-time feedback during the tracking by sending, to the display for presentation, a visual effect separate from the target movement pattern, the visual effect indicating a deviation of the attempt from the target movement pattern based on the comparison.

19. The system of claim 18, wherein the processor is further to generate a three-dimensional model of the target movement pattern; and
wherein to present the visual display, the display is further to present the three-dimensional model within a three-dimensional environment around the user, wherein the display is an immersive headset.

20. The system of claim 19, wherein to present the visual display, the display is further to present a three-dimensional target within the three-dimensional environment for the user to move a specified body part to during the attempt.

21. A method comprising:
presenting a visual display of a target movement pattern for a user to mimic, the target movement pattern including a benchmark spatial path;
tracking, using a sensor, the user during an attempt to mimic the target movement pattern, the attempt including a trial spatial path;
evaluating a comparison between the trial spatial path to the benchmark spatial path; and
providing real-time feedback during the tracking by playing a sound, the sound representing a change to be made to align the attempt to the target movement pattern.

22. The method of claim 21, wherein the sound includes a dynamic center of frequency between 2000 Hz and 5000 Hz.

23. The method of claim 21, further comprising presenting, before the attempt to mimic the target movement pattern, a target for the user to hit during the attempt, and removing the target from view before the user begins the attempt.

24. A system comprising:
a display to present a visual display of a target movement pattern for a user to mimic, the target movement pattern including a benchmark spatial path;
a processor to:
track, using data received from a sensor, the user during an attempt to mimic the target movement pattern, the attempt including a trial spatial path;
evaluate a comparison between the trial spatial path to the benchmark spatial path; and
provide real-time feedback during the tracking by playing a sound, the sound representing a change to be made to align the attempt to the target movement pattern.

25. The system of claim 24, wherein the sound includes a dynamic center of frequency between 2000 Hz and 5000 Hz.
